(19) United States
(12) Patent Application Publication
(10) Pub. No.: US 2016/0251506 A1
(43) Pub. Date: Sep. 1, 2016

(54) POLYPROPYLENE-GRAPHENE COMPOSITE AND METHOD FOR PREPARING THE SAME

(71) Applicants: Hyundai Motor Company, Seoul (KR); Kyungpook National University Industry-Academic Cooperation Foundation, Daegu (KR)

(72) Inventors: Nak Kyoung KONG, Seongnam-si (KR); Hyun Sub KIM, Seoul (KR); Jin Hee LEE, Seoul (KR); Bock Ceol LEE, Suwon-si (KR); Young Sub OH, Suwon-si (KR); Soo Young PARK, Daegu (KR); Sung Moon CHOI, Daegu (KR); Jae Hun WOO, Daegu (KR)

(73) Assignees: Hyundai Motor Company, Seoul (KR); Kyungpook National University Industry-Academic Cooperation Foundation, Daegu (KR)

(21) Appl. No.: 14/949,488

(22) Filed: Nov. 23, 2015

(30) Foreign Application Priority Data
Feb. 27, 2015 (KR) 10-2015-0028049

(51) Int. Cl. C08L 23/12; C08K 9/06; C08J 3/22

(52) U.S. Cl. CPC C08L 23/12; C08J 3/22; C08K 9/06; C08J 2323/12; C08J 2451/06; C08L 2310/00

(57) ABSTRACT

The present invention provides relates to a polypropylene-graphene composite and a method for preparing the same, and in particular, relates to a polypropylene-graphene composite more uniformly dispersing graphene oxide into a polypropylene polymer substrate without graphene oxide aggregation and thereby obtaining an effect of enhancing mechanical properties of the composite even when a small amount of graphene oxide is added, by, in preparing the composite from mixing graphene oxide to a polypropylene polymer substrate, activing a surface of the graphene oxide with aminoalkyl trialkoxysilane, then preparing graphene oxide master batch powder organophilized through an amide bond with maleic anhydride-grafted polypropylene and mixing the graphene oxide master batch powder, and a method for preparing the same.

### CROSS-REFERENCE TO RELATED APPLICATION

This application claims priority under 35 U.S.C. 119(a) to Korean Patent Application No. 10-2015-0028049 filed on Feb. 27, 2015, the entire contents of which are incorporated herein by reference.

### BACKGROUND

1. Technical Field

The present disclosure relates to a polypropylene-graphene composite and a method for preparing the same. More particularly, it relates to a polypropylene-graphene composite more uniformly dispersing graphene oxide into a polypropylene polymer substrate without graphene oxide aggregation and thereby obtaining an effect of enhancing mechanical properties of the composite even when a small amount of graphene oxide is added, by, in preparing the composite from mixing graphene oxide to a polypropylene polymer substrate, activing a surface of the graphene oxide with aminoalkyl trialkoxysilane, then preparing graphene oxide master batch powder organophilized through an amide bond with maleic anhydride-grafted polypropylene and mixing the graphene oxide master batch powder, and a method for preparing the same.

2. Background Art

Polypropylene has small specific gravity, has more excellent transparency and tensile strength than polyethylene, and particularly has a unique hinge property resistant to repetitive bending, and consequently, has been highly favored as a plastic material substituting vehicular components. In addition, polypropylene has excellent high stiffness, impact resistance, transparency and high flowability, and accordingly, has been widely used not only in an automobile industry, but also as a raw material of home appliances, disposable syringes, transparent containers, sanitary nonwoven fabric, packaging films and the like.

When polypropylene is prepared as a composite in which an inorganic reinforcement material such as glass fiber is added, there is an advantage in that relatively low physical properties compared to engineering plastic may be reinforced and the price is low. Recently, researches on polypropylene nanocomposites using carbon materials such as fullerene, carbon nanotubes, nanographite fibers and graphene have been actively progressed, and interests in reinforcing materials having electrical conductivity and thermal conductivity as well as increasing mechanical properties tend to be rising. However, polypropylene is a chemical structurally non-polar material and is thereby aggregated due to low dispersibility of carbon materials leading to a problem of making the physical properties of a composite weak. In view of the above, development of a new polypropylene composite maximizing carbon material dispersibility, and capable of more enhancing mechanical properties even when a small amount of carbon materials is used has been required.

Prior art inventions relating to polypropylene nanocomposites are as follows.

Patent Document 1 discloses a nanocomposite material mixing graphene (G-OH), in which many hydroxyl groups are present by surface modification using alcohol, to a polypropylene polymer (PP) substrate. Patent Document 2 discloses a nanocomposite material mixing multi walled carbon nanotubes (MWCNT-COOH), to which a carboxyl group is introduced by acid treatment, to a maleic anhydride-grafted polypropylene (MA-g-PP) substrate. Patent Document 3 discloses a nanocomposite prepared by mixing a master batch suspension, in which carbon nanobodies of carbon nanotubes and/or graphene are dispersed into a liquid medium, to a polypropylene polymer (PP) substrate. Patent Document 4 discloses a polypropylene-based resin composition including maleic anhydride-grafted polypropylene (MA-g-PP), clay organified with an alkyl ammonium, and flame retardant in a mixed resin of polypropylene and polyethylene.

In Patent Document 4, maleic anhydride-grafted polypropylene (MA-g-PP) is used as a compatibilizer in order to uniformly disperse the organified clay into the polypropylene polymer (PP) substrate.

### PRIOR ART DOCUMENTS

### Patent Documents

(Patent Document 1) Korean Patent Application Laid-Open Publication No. 10-2013-0031629 “Method for reforming of graphene and method for manufacturing nanocomposite materials using the same”

(Patent Document 2) Korean Patent Application Laid-Open Publication No. 10-2011-0016298 “Polypropylene-graft-maleic anhydride/carbon nanotube nanocomposites with excellent thermal stability and electrical conductivity”

(Patent Document 3) Korean Patent Application Laid-Open Publication No. 10-2011-0087456 “Effective dispersion of carbon nano material to generate electrically high performance polymer”

(Patent Document 4) Korean Patent No. 10-0745144 “Polypropylene resin composite with improved mechanical and fire retardant properties and cable using thereoft

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

In view of the above, the inventors of the present invention have attempted to prepare a new polypropylene-graphene composite capable of obtaining a sufficient physical property enhancing effect even when a small amount of a carbon material is mixed to a polypropylene polymer substrate. As a result, the inventors of the present invention have developed a technology of preparing a graphene oxide master batch in which the surface of a graphene oxide (GO) surface is modified through a chemical bonding of aminoalkyl trialkoxysilane, and then maleic anhydride-grafted polypropylene (MA-g-PP) is linked to the terminal amine group through an amide bond, and then mixing the master batch to a polypropylene polymer substrate, and have completed the present invention. In other words, the inventors of the present invention have identified that, when a graphene oxide master batch is prepared and mixed as proposed in the present invention, aggregation of the graphene oxide particles may be avoided, and the graphene oxide may be more uniformly dispersed into a polypropylene polymer substrate through a functional group of the maleic anhydride-grafted polypropylene (MA-g-PP) that forms chemical bonding to the graphene oxide, and have completed the present invention.

Accordingly, an object of the present invention is to provide a polypropylene-graphene composite having excellent mechanical properties such as length modulus, strength and toughness even when a small amount of graphene oxide (GO) is mixed by using a graphene oxide master batch prepared through surface modification and organophilization.

In addition, another object of the present invention is to provide a method for preparing a graphene oxide master batch.

Furthermore, still another object of the present invention is to provide a method for preparing a polypropylene-graphene composite using a graphene oxide master batch.

In one aspect, the present invention provides a polypropylene composite including a polypropylene polymer substrate; and an organophilized graphene oxide master batch prepared by reacting graphene oxide of which surface is modified with aminoalkyl trialkoxysilane, and maleic anhydride-grafted polypropylene.

In another aspect, the present invention provides a method for preparing a graphene oxide master batch including (i) activating a surface of graphene oxide by treating the graphene oxide (GO) with ultrasonic waves; (ii) preparing surface-modified graphene oxide by reacting the surface-activated graphene oxide and aminoalkyl trialkoxysilane; and (iii) preparing an organophilized graphene oxide master batch by reacting the surface-modified graphene oxide with maleic anhydride-grafted polypropylene after treating the surface-modified graphene oxide with ultrasonic waves.

In still another aspect, the present invention provides a method for preparing a polypropylene-graphene composite including (i) activating a surface of graphene oxide by treating the graphene oxide (GO) with ultrasonic waves; (ii) preparing surface-modified graphene oxide by reacting the surface-activated graphene oxide and aminoalkyl trialkoxysilane; (iii) preparing an organophilized graphene oxide master batch by reacting the surface-modified graphene oxide with maleic anhydride-grafted polypropylene after treating the surface-modified graphene oxide with ultrasonic waves in a solvent; and (iv) preparing a polypropylene-graphene composite by mixing a polypropylene polymer substrate and the graphene oxide master batch.

Other aspects and preferred embodiments of the invention are discussed infra.

It is understood that the term embodiments of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 shows IR spectra identifying chemical bonding in each preparation process for preparing a graphene oxide master batch: (A) is an IR spectrum of graphene oxide (GO) used as a raw material; (B) is an IR spectrum of graphene oxide of which surface is modified with aminoalkyl trialkoxysilane; and (C) is an IR spectrum of graphene oxide master batch powder organophilized by reacting maleic anhydride-grafted polypropylene to a terminal amine group of the surface-modified graphene oxide.

FIG. 2 is an electron microscope photograph for a specimen molded as a film using a polypropylene-graphene composite prepared in (a) Example 1 and (b) Comparative Example 4.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The present invention relates to a polypropylene/graphene composite in which a specific graphene oxide master batch is mixed to a polypropylene polymer substrate, a method for preparing the same, and a method for preparing the specific graphene oxide master batch.

Specifically, in mixing graphene oxide (GO) to a polypropylene polymer substrate, the present invention prepares a graphene oxide master batch through surface modification and organophilization of the graphene oxide (GO) and mixes the graphene oxide master batch.

The graphene oxide master batch used in the present invention may be prepared in a powder phase. The graphene oxide master batch in a powder phase has an advantage in that uniform dispersion is readily achieved when being mixed to a polypropylene polymer substrate.

The graphene oxide master batch used in preparing the polypropylene-graphene composite in the present invention may be represented by the following Chemical Formula 1.

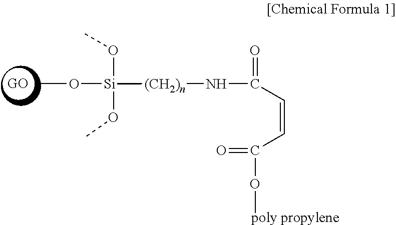

In Chemical Formula 1, n is an integer of 1 to 10 (i.e., 1, 2, 3, 4, 5, 6, 7, 8, 9, or 10), and preferably an integer of 1 to 6. Dashed lines represent moieties R₁ and R₃ from Chemical Formula 2.

As represented by Chemical Formula 1, a surface modification portion of aminoalkyl trialkoxysilane (AATA-Si) and an organophilization portion of maleic anhydride-grafted polypropylene (MA-g-PP) are present chemical bonding to each other on the surface of graphene oxide (GO) particles in the graphene oxide master batch of the present invention.

In order to disperse clay into a polypropylene polymer substrate, technologies of modifying the clay surface with an alkyl ammonium compound, and mixing maleic anhydride-grafted polypropylene (MA-g-PP) thereto as a compatibilizer so that the clay particles are uniformly dispersed into the polypropylene polymer substrate have been tried. However, a technology of separately preparing a graphene oxide master batch having a structure of Chemical Formula 1 and mixing the master batch to a polypropylene polymer substrate has not been established so far, and the present invention proposes the technology for the first time. The present invention prepares graphene oxide as a master batch having the structure of Chemical Formula 1, and mixes the master batch to a polypropylene polymer substrate, and as a result, suppresses aggregation of the graphene oxide, which has been a problem in existing technologies of mixing graphene oxide in a mixture form, and obtains an effect of uniformly dispersing the graphene oxide into the polypropylene polymer substrate through maleic anhydride-grafted polypropylene linked to the graphene oxide by chemical bonding.

The method for preparing a graphene oxide master batch according to the present invention includes, (i) activating a surface of graphene oxide by treating the graphene oxide (GO) with ultrasonic waves; (ii) preparing surface-modified graphene oxide by reacting the surface-activated graphene oxide and aminoalkyl trialkoxysilane; and (iii) preparing an organophilized graphene oxide master batch by reacting the surface-modified graphene oxide with maleic anhydride-grafted polypropylene after treating the surface-modified graphene oxide with ultrasonic waves.

In addition, the method for preparing a polypropylene-graphene composite includes (i) activating a surface of graphene oxide by treating the graphene oxide (GO) with ultrasonic waves; (ii) preparing surface-modified graphene oxide by reacting the surface-activated graphene oxide and aminoalkyl trialkoxysilane; (iii) preparing an organophilized graphene oxide master batch by reacting the surface-modified graphene oxide with maleic anhydride-grafted polypropylene after treating the surface-modified graphene oxide with ultrasonic waves in a solvent; and (iv) preparing a polypropylene-graphene composite by mixing a polypropylene polymer substrate and the graphene oxide master batch.

The method for preparing a graphene oxide master batch and a method for preparing a polypropylene-graphene composite according to the present invention are described more specifically as follows.

The step (i) is a step of activing a surface of graphene oxide.

Graphene oxide (GO) is generally prepared by oxidizing graphite powder using an oxidizing agent such as nitric acid, sodium chlorate (NaClO₃), potassium chlorate (KClO₃) and potassium permanganate (KMnO₄), or prepared by oxidizing graphite powder using an electrochemical method. The ratio of oxygen:carbon atom numbers in graphene oxide is approximately 1:1 to 20, however, the ratio may be smaller or larger than the above-mentioned value depending on the degree of oxidation. Graphene oxide normally has an interlayer distance of approximately 7 Å, and shows a peak around 2θ=13° in a wide angle X-ray diffraction analysis, however, the values may be different depending on the degree of oxidation and the degree of moisture absorption.

In the present invention, the surface of graphene oxide (GO) is activated through treatment with ultrasonic waves prior to preparing a graphene oxide master batch so that reaction efficiency in a modification reaction progressed thereafter is maximized. In addition, graphene stacked in multilayers may be present in the graphene oxide used as a raw material, and an effect of more readily dispersing the graphene oxide in an organic solvent is also expected by the graphene oxide being stripped in layers through treatment with ultrasonic waves.

Specifically, the activation is carried out by dispersing graphene oxide (GO) in an organic solvent of aromatic hydrocarbon series such as toluene and xylene, and then treating the result with ultrasonic waves. The ultrasonic waves have a frequency range of from about 20 to about 100 kHz, and the treatment is accomplished by being carried out for approximately 1 to 3 hours.

The step (ii) is a step of modifying the surface of the graphene oxide.

In the present invention, the surface of the graphene oxide activated through treatment with ultrasonic waves is modified with aminoalkyl trialkoxysilane. Specifically, when aminoalkyl trialkoxysilane is added to the graphene oxide suspension treated with ultrasonic waves and the result is stirred, oxygen anions (O⁻) present on the surface of the graphene oxide are reacted with alkoxy groups of the aminoalkyl trialkoxysilane (AATA-Si) to chemically bond to the surface of the graphene oxide.

The aminoalkyl trialkoxysilane (AATA-Si) used for modifying the surface of the graphene oxide may be represented by the following Chemical Formula 2.

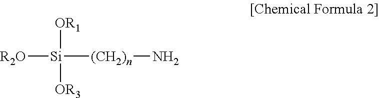

In Chemical Formula 2, R₁, R₂, and R₃ are each an alkyl group having 1 to 6 carbon atoms (i.e., C₁, C₂, C₃, C₄, C₅, or C₆ alkyl), and n is an integer of 1 to 10 (i.e., 1, 2, 3, 4, 5, 6, 7, 8, 9, or 10).

Specific examples of the aminoalkyl trialkoxysilane represented by Chemical Formula 2 may include 3-aminopropyltrimethoxy silane, 3-aminopropyltriethoxy silane, 5-aminopentyldimethoxyethoxy silane and the like. The amount of the aminoalkyl trialkoxysilane represented by Chemical Formula 2 used may be different depending on the degree of oxidation of the graphene oxide, however, the aminoalkyl trialkoxysilane may be used in a range of from about 0.01 to about 0.1 parts by weight, and preferably in a range of from about 0.01 to about 0.05 parts by weight with respect to about 100 parts by weight of the graphene oxide (GO). Herein, when the amount of the aminoalkyl trialkoxysilane represented by Chemical Formula 2 used is small less than about 0.01 parts by weight, modification does not effectively occur on the surface of the graphene oxide causing a problem of organophilization progressed thereafter being minimally accomplished. On the contrary, when the amount of the aminoalkyl trialkoxysilane represented by Chemical Formula 2 used is excessive greater than about 0.1 parts by weight, the content of the graphene oxide (GO) in the composite decreases, and a composite effect may not be obtained.

The temperature of the reaction with aminoalkyl trialkoxysilane for modifying the surface of the graphene oxide (GO) is in a range of from about 10° C. to about 30° C., and the reaction is smoothly progressed even when the temperature is maintained around room temperature. The reaction time is suitably from about 10 to about 15 hours.

The step (iii) is a step of preparing a graphene oxide master batch by organophilizing the graphene oxide.

In the present invention, organophilization is carried out by bonding maleic anhydride-grafted polypropylene (MA-g-PP) to a terminal amine group of the graphene oxide of which surface is modified with aminoalkyl trialkoxysilane through formation of an amide. Specifically, after the surface-modified graphene oxide is dispersed into an organic solvent of aromatic hydrocarbon series such as toluene and xylene, the result is treated with ultrasonic waves, maleic anhydride-grafted polypropylene (MA-g-PP) is added thereto, and then the result is stirred.

In the organophilization reaction, surface-modified graphene oxide is reacted in from about 5 to about 15 parts by weight with respect to about 100 parts by weight of the maleic anhydride-grafted polypropylene (MA-g-PP). Herein, when the content of the surface-modified graphene oxide included in the graphene oxide master batch is less than about 5 parts by weight, an effect of a graphene oxide addition through the polypropylene-graphene composite preparation is difficult to be expected, and when the content is excessive greater than about 15 parts by weight, uniform dispersion of the graphene oxide may not be expected when preparing a polypropylene-graphene composite.

The maleic anhydride-grafted polypropylene (MA-g-PP) used for organophilizing the graphene oxide (GO) is a material widely used in the art, and may be purchased as a product, or may also be prepared by graft bonding a polypropylene end with maleic anhydride. In the present invention, using those having a maleic anhydride to polypropylene graft ratio of from about 1% to about 2% is favorable.

The organophilization reaction is carried out under a condition of heating at from about 100° C. to about 170° C. and preferably at from about 130° C. to about 150° C. under the presence of an inert gas such as nitrogen. The reaction time is suitably from about 2 to about 5 hours.

The graphene oxide master batch prepared through the above-mentioned organophilization reaction may be obtained in a powder form.

The step (iv) is a step of preparing a polypropylene-graphene composite.

In the present invention, a composite is prepared by compounding the graphene oxide master batch prepared in the step (iii) with a widely used polypropylene polymer substrate. Specifically, a polypropylene-graphene composite is prepared using an extruder such as a twin-screw extruder after mixing a polypropylene polymer substrate and the graphene oxide master batch.

In preparing the polypropylene-graphene composite of the present invention, the graphene oxide master batch may be mixed in a range of from about 0.1 to about 3 parts by weight and preferably in a range of from about 0.3 to about 2 parts by weight based on about 100 parts by weight of the polypropylene polymer substrate. When the content of the graphene oxide master batch included in the polypropylene-graphene composite of the present invention is less than about 0.1 parts by weight, the content of the graphene oxide (GO) included in the composite is too small and an effect of enhancing mechanical properties may not be expected, and when the content is excessive greater than about 3 parts by weight, dispersibility of the graphene oxide (GO) in the composite decreases causing a problem of degrading physical properties of the composite, and therefore, using the graphene oxide master batch in the above range is favorable.

As described above, the present invention mixes graphene oxide (GO) mixed to a polypropylene polymer substrate as a master batch through a process of surface modification and organophilization using a specific compound, and therefore, induces uniform dispersion of the graphene oxide (GO) in the composite, and as a result, an effect of enhancing mechanical properties, which is a target effect, may be obtained just by containing a small amount of the graphene oxide (GO).

### EXAMPLES

Hereinafter, the present invention will be described in more detail with reference to examples. However, these examples are for illustrative purposes only, and the scope of the present invention is not limited thereto.

### Example

### Preparation Example

### Preparation of Graphene Oxide Master Batch

0.5 g of graphene oxide (GO, TIMCAL Graphite & Carbon, TIMREX graphite-BNB90) was placed in 20 ml of a toluene solvent, the result was treated with ultrasonic waves for 2 hours, and a black toluene solution in which the graphene oxide was dispersed was obtained.

400 μl of 3-aminopropyltriethoxy silane (Si(OEt)₃(CH₂CH₂CH₂NH₂)) was added to the solution, the result was stirred for 12 hours at room temperature to obtain a black solution. Next, the result was filtered using dichloromethane, washed, and then dried for 10 hours at a temperature of 60° C. to obtain surface-modified graphene oxide.

After placing and dispersing the surface-modified graphene oxide in 40 ml of xylene, the result was treated with ultrasonic waves for 1 hour. 5 g of maleic anhydride-grafted polypropylene (MA-g-PP, graft ratio 2%; Chemtura Corporation, MAPP-Polybond3000) was introduced thereto, and the result was stirred under a nitrogen current for 3 hour at a temperature of 140° C. After the reaction was complete, the reaction solution was placed in 120 ml of methanol, and aggregated dark grey powder was formed. After the powder was collected by filtration, the powder was washed with methanol, dried for 24 hours at 80° C. to obtain graphene oxide master batch powder.

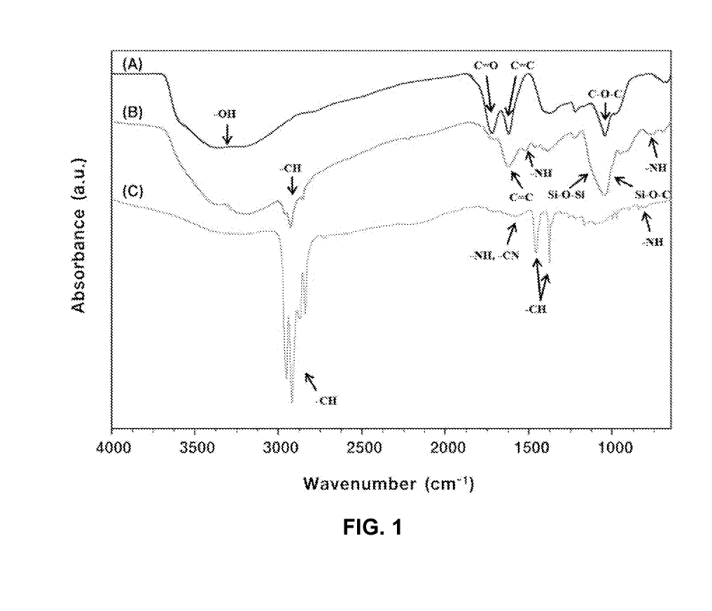

In FIG. 1, an IR spectrum identifying chemical bonding in each preparation process for preparing the graphene oxide master batch is attached. In other words, it can be identified that 3-aminopropyltriethoxy silane and maleic anhydride-grafted polypropylene were introduced through chemical bonding on the surface of the graphene oxide (GO) through surface modification and organophilization according to (A), (B) and (C) of FIG. 1.

(A) of FIG. 1 is an IR spectrum of the graphene oxide (GO) used as a raw material, and a hydroxyl peak was observed at a position of 3380 cm⁻¹, a carboxyl peak was observed at a position of 1721 cm⁻¹, a sp²-hybrid C═C (in plane vibrations) peak was observed at a position of 1622 cm⁻¹, and an epoxy peak was observed at a position of 1048 cm⁻¹.

(B) is an IR spectrum of the graphene oxide of which surface was modified with 3-aminopropyltriethoxy silane, and C—H bond peaks caused by a CH₂—CH₂ group of the 3-aminopropyltriethoxy silane were observed at positions of 2933 and 2863 cm⁻¹, N—H stretching peaks were observed at positions of 1522 and 778 cm⁻¹, and a Si—O—Si stretching and a Si—O—C stretching peak were observed at positions of 1119 and 1005 cm⁻¹, respectively.

(C) is an IR spectrum of the graphene oxide master batch prepared by reacting the maleic anhydride-grafted polypropylene, and an amide bond peak was observed at a position of 1650 cm⁻¹.

### Examples 1 to 7 and Comparative Examples 1 and 2

### Preparation of Composite Including Graphene Oxide (GO) Master Batch Powder

A polypropylene-graphene composite was prepared by mixing the graphene oxide master batch powder prepared in the preparation example to a polypropylene polymer substrate (Lotte Chemical Corporation, SEP-550H grade) in the content shown in the following Table 1, and mixing the result with 100 L/min for 10 minutes at 190° C. using Plastograph™ EC and Mixer W 50 EHT of Brabender GmbH Co. KG.

### Comparative Example 3

### Preparation of Virgin PP

Virgin PP was prepared by melting a polypropylene polymer substrate (Lotte Chemical Corporation, SEP-550H grade) with 100 L/min for 10 minutes at 190° C. using Plastograph™ EC and Mixer W 50 EHT of Brabender GmbH Co. KG.

### Comparative Example 4

### Preparation of Composite Including Graphene Oxide (GO)

A polypropylene-graphene composite was prepared by mixing 0.03 parts by weight of graphene oxide (GO, TIMCAL Graphite & Carbon, TIMREX graphite-BNB90) to 100 parts by weight of a polypropylene polymer substrate (Lotte Chemical Corporation, SEP-550H grade), and melting the result with 100 L/min for 10 minutes at 190° C. using Plastograph™ EC and Mixer W 50 EHT of Brabender GmbH Co. KG.

### Comparative Example 5

### Preparation of Composite Including Mixture of Graphene Oxide (GO) and Maleic Anhydride-Grafted Polypropylene (MA-g-PP)

A polypropylene-graphene composite was prepared by mixing 0.03 parts by weight of graphene oxide (GO, TIMCAL Graphite & Carbon, TIMREX graphite-BNB90) and 0.3 parts by weight of maleic anhydride-grafted polypropylene (MA-g-PP, graft ratio 2%, Chemtura Corporation, MAPP-Polybond3000) to 100 parts by weight of a polypropylene polymer substrate (Lotte Chemical Corporation, SEP-550H grade), and melting the result with 100 L/min for 10 minutes at 190° C. using Plastograph™ EC and Mixer W 50 EHT of Brabender GmbH Co. KG.

### Test Example

### Physical Property Measurement

The polypropylene-graphene composite prepared in Examples 1 to 7 and Comparative Examples 1 to 5 was pressurized using a hot press machine heated to 250° C. to prepare a film having a thickness of approximately 0.5 mm, and was cut into a die having a dumbbell shape with an external length of 75 mm, a width of 10 mm, an internal length of 20 mm and a width of 4 mm to each prepare a specimen film having the same size.

For the specimen prepared as above, physical properties were measured as follows.

Tensile strength measurement: the crosshead was measured at a rate of approximately 50 mm/min using a universal test machine (Instron, Model 4465, USA).

Length modulus measurement: the crosshead was measured at a rate of approximately 50 mm/min using a universal test machine (Instron, Model 4465, USA).

Toughness measurement: the crosshead was measured at a rate of approximately 50 mm/min using a universal test machine (Instron, Model 4465, USA).

Results of measuring tensile strength, length modulus and toughness of each composite specimen of Examples 1 to 7 and Comparative Examples 1 to 5 are summarized and shown in the following Table 1.

TABLE 1

| | Composition Ratio of | | | | |
|---|---|---|---|---|---|
| | Composite | | | | |
| | (Parts by Weight) | | | | |
| | | Graph- | | | |
| | | ene | | | |
| | Polypropylene | Oxide | Tensile | Length | |
| | Polymer | Master | Strength | Modulus | Toughness |
| Category | Substrate | Batch | (MPa) | (MPa) | (MPa) |
| Example 1 | 100 | 0.3 | 37.8260 | 501.0600 | 300.3600 |
| Example 2 | 100 | 0.6 | 38.0524 | 536.5000 | 302.7800 |
| Example 3 | 100 | 0.9 | 39.1000 | 614.5800 | 321.7000 |
| Example 4 | 100 | 1.2 | 37.9520 | 597.4000 | 315.4000 |
| Example 5 | 100 | 1.5 | 37.2784 | 618.8400 | 316.7000 |
| Example 6 | 100 | 2.0 | 36.2415 | 602.0145 | 300.2142 |
| Example 7 | 100 | 3.0 | 35.3041 | 580.7452 | 290.1786 |
| Comparative | 100 | 0.01 | 33.4863 | 456.3200 | 260.9100 |
| Example 1 | | | | | |
| Comparative | 100 | 5.0 | 28.2413 | 490.1423 | 270.2443 |
| Example 2 | | | | | |
| Comparative | 100 | — | 27.0920 | 362.0400 | 193.9200 |
| Example 3¹⁾ | | | | | |
| Comparative | 100 | — | 28.0149 | 390.1473 | 198.2674 |
| Example 4²⁾ | | | | | |
| Comparative | 100 | — | 30.5815 | 423.2900 | 205.4000 |
| Example 5³⁾ | | | | | |

¹⁾Comparative Example 3 used Virgin PP
²⁾Comparative Example 4 mixed 0.03 parts by weight of the graphene oxide instead of the graphene oxide master batch.
³⁾Comparative Example 5 mixed 0.3 parts by weight of the maleic anhydride-grafted polypropylene and 0.03 parts by weight of the graphene oxide instead of the graphene oxide master batch.

It was identified that the composite specimen (Examples 1 to 7 and Comparative Examples 1 and 2) in which the oxidized master batch was mixed to the polypropylene polymer substrate all had increased tensile strength, length modulus and toughness when compared to the polypropylene polymer substrate (Virgin PP) specimen (Comparative Example 3). Among the specimens of Examples 1 to 7, it was identified that the specimen (Example 3) including the graphene oxide master batch in 0.9 parts by weight had most excellent tensile strength, length modulus and toughness. In addition, it was identified that, when the content of the graphene oxide master batch was out of the range of 0.1 to 3 parts by weight in mixing the graphene oxide master batch to the polypropylene polymer substrate, as in Comparative Example 1 or Comparative Example 2, tensile strength, length modulus and toughness decreased.

In addition, it was identified that, when compared to the specimen (Comparative Example 4) in which graphene oxide (GO) was directly mixed to the polypropylene polymer substrate, the specimens of Examples 1 to 7, in which graphene oxide (GO) was prepared as a master batch and mixed, all had increased tensile strength, length modulus and toughness.

Furthermore, Example 1, Comparative Example 4 and Comparative Example 5 all had the same graphene oxide (GO) content of 0.03 parts by weight in the composite based on 100 parts by weight of the polypropylene polymer substrate, however, it was identified that the specimen of Example 1, in which graphene oxide was mixed as a master batch, had far more excellent tensile strength, length modulus and toughness. Through such results, it can be seen that mixing graphene oxide after preparing as a master batch through specific surface modification and organophilization as proposed in the present invention is effective in obtaining preferable results in terms of enhancing physical properties of the composite.

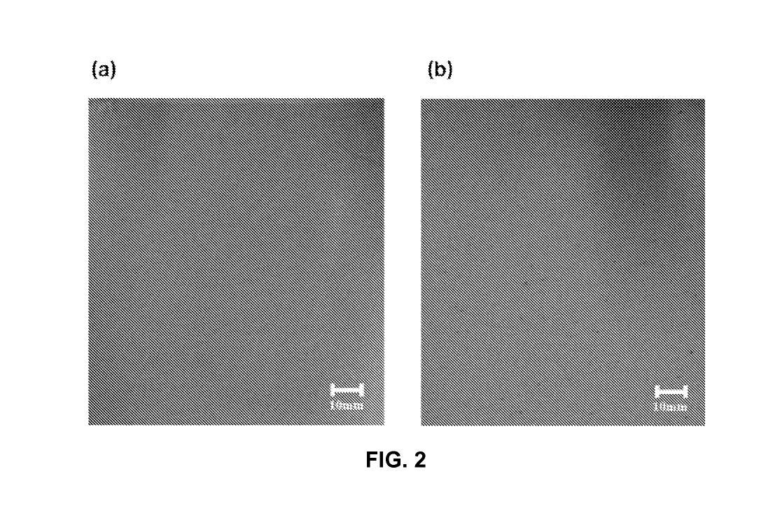

In addition, in FIG. 2 an electron microscope photograph for a specimen molding the composite of Example 1 and Comparative Example 4 as a film is attached.

(a) of FIG. 2 is a photograph of the specimen of Example 1, and no aggregation phenomenon was observed. However, (b) of FIG. 2 is a photograph of the specimen of Comparative Example 4, and black spots were identified. Through such results, it was identified that mixing graphene oxide by preparing as a master batch through specific surface modification and organophilization as proposed in the present invention induces uniform dispersion without aggregation of the graphene oxide (GO).

Accordingly, the polypropylene-graphene composite provided in the present invention has excellent physical properties such as tensile strength, length modulus and toughness, and dispersibility compared to a polypropylene composite prepared through general methods, and therefore, may be used in various fields such as automotive and IT fields.

According to the present invention, dispersibility of the graphene oxide master batch in the polypropylene polymer substrate is excellent, and therefore, it is effective in that the prepared polypropylene-graphene composite has excellent physical properties even when a small of amount of graphene oxide is mixed.

The polypropylene-graphene composite of the present invention has excellent mechanical properties such as length modulus, strength and toughness, and therefore, may be used in various fields such as automotive and IT fields.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A polypropylene-graphene composite comprising:
a polypropylene polymer substrate; and
an organophilized graphene oxide master batch prepared by a method comprising:
(i) activating a surface of graphene oxide (GO), thereby preparing a surface-activated graphene oxide;
(ii) contacting said surface-activated graphene oxide with aminoalkyl trialkoxysilane, thereby preparing a surface-modified graphene oxide;
(iii) reacting said surface-modified graphene oxide with maleic anhydride-grafted polypropylene.

2. The polypropylene-graphene composite of claim 1, comprising the polypropylene polymer substrate in about 100 parts by weight; and the graphene oxide master batch in from about 0.1 to about 3 parts by weight.

3. The polypropylene-graphene composite of claim 1 or 2, wherein the graphene oxide master batch is a powder.

4. The polypropylene-graphene composite of claim 1 or 2, wherein the graphene oxide master batch is prepared by reacting the surface-modified graphene oxide in from about 5 to about 15 parts by weight with respect to about 100 parts by weight of the maleic anhydride-grafted polypropylene.

5. The polypropylene-graphene composite of claim 1, wherein the graphene oxide master batch has a structure according to Chemical Formula 1: 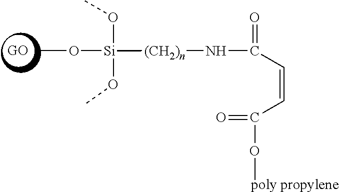
wherein n is an integer of 1 to 10; and the dashed lines each independently represent a C₁-C₆ alkyl group.

6. A method for preparing a graphene oxide master batch comprising
(i) activating a surface of graphene oxide by treating the graphene oxide with ultrasonic waves;
(ii) preparing surface-modified graphene oxide by reacting the surface-activated graphene oxide and aminoalkyl trialkoxysilane; and
(iii) preparing an organophilized graphene oxide master batch by reacting the surface-modified graphene oxide with maleic anhydride-grafted polypropylene after treating the surface-modified graphene oxide with ultrasonic waves.

7. A method for preparing a polypropylene-graphene composite comprising:
(i) activating a surface of graphene oxide by treating the graphene oxide with ultrasonic waves;
(ii) preparing surface-modified graphene oxide by reacting the surface-activated graphene oxide and aminoalkyl trialkoxysilane;
(iii) preparing an organophilized graphene oxide master batch by reacting the surface-modified graphene oxide with maleic anhydride-grafted polypropylene after treating the surface-modified graphene oxide with ultrasonic waves; and
(iv) preparing a polypropylene-graphene composite by mixing a polypropylene polymer substrate and the graphene oxide master batch.

8. The method of claim 6 or 7, wherein the graphene oxide master batch is a powder.

9. The method of claim 6 or 7, wherein the graphene oxide master batch of step (iii) is prepared by reacting the surface-modified graphene oxide in from about 5 to about 15 parts by weight with respect to about 100 parts by weight of the maleic anhydride-grafted polypropylene.

10. The method of claim 7, wherein the step (iv) prepares the polypropylene-graphene composite by mixing about 100 parts by weight of the polypropylene polymer substrate and from about 0.1 to about 3 parts by weight of the graphene oxide master batch.
